(19) United States
(12) Patent Application Publication
(10) Pub. No.: US 2026/0312647 A1
(43) Pub. Date: Oct. 8, 2026

(54) CHANNEL STATE INFORMATION (CSI) REPORTING FOR COHERENT JOINT TRANSMISSION BASED ON CSI PROCESSING UNITS (CPUS)

(71) Applicant: Telefonaktiebolaget LM Ericsson (publ), Stockholm (SE)

(72) Inventors: Shiwei GAO, Nepean (CA); Siva MURUGANATHAN, Stittsville (CA); Xinlin ZHANG, Göteborg (SE)

(21) Appl. No.: 19/481,443

(22) PCT Filed: May 8, 2024
(86) PCT No.: PCT/IB2024/054499

§ 371 Date: Nov. 4, 2025

Related U.S. Application Data
(60) Provisional application No. 63/500,796, filed on May 8, 2023.

(51) Int. Cl. H04B 7/06

(52) U.S. Cl. CPC H04B 7/0626

(57) ABSTRACT

A method, system and apparatus are disclosed. According to some embodiments, a method implemented by a user equipment is provided. The method includes receiving from a network node an indication triggering a CSI report for CJT where the CIS report is based on a plurality of CSI-RS resources, determining a first number of CPUs required to process a CSI report based at least on a number of the plurality of CSI-RS resources and a second number of CSI processing units required for each of the plurality of CSI-RS resources, processing the CSI report based on the determined first number of CSI processing units, and reporting the CSI report to the network node.

### FIELD

The present disclosure relates to wireless communications, and in particular, to feedback reporting based on wireless device/user equipment processing resources.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

NR uses CP-OFDM (Cyclic Prefix Orthogonal Frequency Division Multiplexing) in both the downlink (DL) (i.e., from a network node (e.g., gNB, or base station) to a wireless device (e.g., user equipment or UE) and the uplink (UL) (i.e., from the wireless device to the network node). DFT spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically on a slot basis. An example is shown in FIG. 1 with a 14-symbol slot, where the first two symbols contain physical downlink control channel (PDCCH) and the remaining symbols contain physical shared data channel, PDSCH (physical downlink shared channel) or PUSCH (physical uplink shared channel).

Different subcarrier spacing (SCS) values are supported in NR. The supported SCS values (also referred to as different numerologies) are given by Δf=(15×2^{μ}) kHz where μ∈{0,1,2,3,4}. Δf=15 kHz is the basic subcarrier spacing. The slot duration for a given subcarrier spacing is

$$\frac{1}{2 μ} ms .$$

In the frequency domain, a system bandwidth is divided into resource blocks (RBs), each corresponds to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

Downlink transmissions to a wireless device can be dynamically scheduled by sending downlink control information (DCI) with a DL DCI format on PDCCH. The DCI contains scheduling information such as time and frequency resources, modulation and coding scheme, etc. The user data are carried on the PDSCH. The wireless device first detects and decodes PDCCH and if the decoding is successful, the wireless device then decodes the corresponding PDSCH according to the scheduling information in the DCI.

Similarly, uplink data transmission can be dynamically scheduled using a UL DCI format on PDCCH. A wireless device first decodes uplink grants in the DCI and then transmits data over PUSCH according to the control information contained in the uplink grant such as modulation order, coding rate, uplink resource allocation, etc.

### Codebook-Based Precoding

Multi-antenna techniques can significantly increase the data rates and reliability of a wireless communication system. The performance may be improved if both the transmitter and the receiver are equipped with multiple antennas, which results in a multiple-input multiple-output (MIMO) communication channel. Such systems and/or related techniques are commonly referred to as MIMO.

One aspect of 4G wireless networks or NR is the support of MIMO antenna deployments and MIMO related techniques such as spatial multiplexing. Spatial multiplexing can be used to increase data rates in favorable channel conditions. FIG. 3 is a diagram of an example of spatial multiplexing. An information carrying data symbol vector s=[s₁, s₂, . . . , sᵣ]^{T} is multiplied by an N_{T}×r precoding matrix or precoder W=[w¹, w², . . . , w^{r}] before being transmitted over N_{T} antennas. sₗ (l, . . . , r) is a data symbol transmitted at the l^{th} MIMO layer and r is the total number of MIMO layers, also referred to as the transmission rank. w^{l}(l=1, . . . , r) is the precoding vector for the l^{th} MIMO layer and serves to distribute the signal energy of the l^{th} layer towards certain directions. Typically, [w¹, w², . . . , w^{r}] are mutually orthogonal, i.e., (wⁱ)^{H} w^{j}=0 for i≠j, where (⋅)^{T} and (⋅)^{H} indicate transpose and Hermitian transpose, respectively. The r symbols are transmitted simultaneously over a same time and frequency resource element (RE), hence spatial multiplexing is achieved.

The received signal on a certain RE at the wireless device equipped with N_{R} receive antennas can be expressed as

$$y = \sqrt[2]{P} HWs + e$$

Where y=[y₁, . . . , y_{N}_{_{R}}]^{T} and yᵢ (i=1, . . . , N_{R}) is the received signal at the i^{th} receive antenna; e=[e₁, . . . , e_{N}_{_{R}}]^{T} is a receiver noise/interference vector, Hₙ is a N_{R}×N_{T} channel matrix, and P is the transmit power.

The precoder W is chosen to match the characteristics of channel matrix H. In FDD systems, it may be recommended by the wireless device based on downlink channel measurements, where the precoding matrix W is typically selected from a codebook and fed back by the wireless device via a precoding matrix indicator (PMI) as part of channel state information (CSI) feedback. For that purpose, the wireless device is configured with a CSI report configuration including CSI reference signals (CSI-RS) for channel measurements and a codebook of candidate precoders. In addition to PMI, the feedback may also include a rank indicator (RI) and one or two channel quality indicators (CQIs). In NR, CSI feedback can be either wideband, where a PMI (and/or a CQI) is reported for the entire channel bandwidth, or frequency-selective, where a PMI (and/or a CQI) is reported for each subband, which is defined as a number of contiguous physical resource blocks (PRBs) ranging between 4-32 PRBs depending on the size of a corresponding band width part (BWP).

For CSI measurement and feedback, CSI-RS is transmitted from every transmit antenna port at the network node and is used by a wireless device to measure a downlink channel between each transmit antenna port at the network node and each of the wireless device's receive antenna ports. The transmit antenna ports are also referred to as CSI-RS ports. The supported number of CSI-RS ports in NR are {1,2,4,8,12,16,24,32}. By measuring the received CSI-RS, a wireless device can estimate the channel that the CSI-RS is traversing, including the radio propagation channel and antenna gains. The CSI-RS described above may correspond to Non-Zero Power (NZP) CSI-RS.

### Channel State Information Reference Signals (CSI-RS)

For CSI measurement and feedback, CSI-RS are defined. A CSI-RS is transmitted on an antenna port at the network node and is used by a wireless device to measure downlink channel between the antenna port and each of the wireless device's receive antenna ports. The transmit antenna ports are also referred to as CSI-RS ports. The supported number of CSI-RS ports in NR are {1, 2, 4, 8, 12, 16, 24, 32}. By measuring the received CSI-RS, a wireless device can estimate the channel that the CSI-RS is traversing, including the radio propagation channel and antenna gains. The CSI-RS described above may correspond to Non-Zero Power (NZP) CSI-RS.

CSI-RS can be configured to be transmitted in certain REs in a slot and certain slots. FIG. 4 is a diagram of an example of CSI-RS REs for 12 antenna ports, where iRE per RB per port is shown.

In addition, interference measurement resource (IMR) is also defined in NR for a wireless device to measure interference. An IMR resource contains 4 REs, either 4 adjacent RE in frequency in the same OFDM symbol or 2 by 2 adjacent REs in both time and frequency in a slot. By measuring both the channel based on NZP CSI-RS and the interference based on an IMR, a wireless device can estimate the effective channel and noise plus interference to determine the CSI. Furthermore, a wireless device in NR may be configured to measure interference based on one or multiple NZP CSI-RS resource.

NZP CSI-RS configuration details are described in 3GPP such as in, for example, in clause 7.4.1.5 of 3GPP TS 38.211 V17.3.0.

### CSI Frame Work in NR

In NR, a wireless device can be configured with multiple CSI reporting settings and multiple CSI-RS resource settings. Each resource setting can contain multiple resource sets, and each resource set can contain up to 8 CSI-RS resources. For each CSI reporting setting, a wireless device feeds back a CSI report.

Each CSI reporting setting contains one or more of:
A CSI-RS resource setting for channel measurement
An IMR resource set for interference measurement
Optionally, a CSI-RS resource set for interference measurement
Time-domain behavior, i.e., periodic, semi-persistent, or aperiodic reporting
Frequency granularity, i.e., wideband or subband
Report quantity: CSI parameters to be reported such as RI, PMI, CQI, and CSI-RS resource indicator (CRI) in case of multiple CSI-RS resources in a resource set
Codebook types, i.e., type I or II, and codebook subset restriction
Measurement restriction
Subband size. One out of two possible subband sizes is indicated, the value range depends on the bandwidth of the BWP. One CQI/PMI (if configured for subband reporting) is fed back per subband).

In NR, CSI-AperiodicTriggerState is configured in order to trigger aperiodic CSI reports. The CSI-AperiodicTriggerList information element (IE) is defined in 3GPP specification such as in, for example, 3GPP TS 38.331 V17.2.0 as follows:

There is list of trigger states which may include up to 128 of CSI-AperiodicTriggerStates. Each trigger state may include up to 16 CSI-AssociatedReportConfigInfo. Each CSI-AssociatedReportConfiglnfo contains a reportconfig id which associates it to a CSI-Reportconfig. Wireless device may have up to 48 different reportconfigs configured. Each Reportconfig includes codebookConfig as a field.

### CSI Processing Criteria

In NR, a wireless device indicates the number of supported simultaneous CSI calculations, N_{CPU}, with parameter simultaneous CSI-ReportsPerCC in a component carrier (CC), and simultaneous CSI-ReportsAllCC across all CCs. If a wireless device supports N_{CPU} simultaneous CSI calculations it is said to have N_{CPU} CSI processing units (CPUs) for processing CSI reports. If L CPUs are occupied for calculation of CSI reports in a given OFDM symbol, the wireless device has N_{CPU}−L unoccupied CPUs. If N CSI reports start occupying their respective CPUs on the same OFDM symbol on which N_{CPU}−L CPUs are unoccupied, where each CSI report n=0, . . . , N−1 corresponds to

$${O}_{CPU}^{( n )} CPUs ,$$

the wireless device is not required to update the N−M requested CSI reports with lowest priority (according to Clause 5.2.5 of 3GPP specification such as, for example, 3GPP TS 38.214), where 0≤M≤N is the largest value such that

$${\sum }_{n = 0}^{M - 1} {O}_{CPU}^{( n )} \leq {N}_{CPU} - L holds .$$

A wireless device is not expected to be configured with an aperiodic CSI trigger state containing more than N_{CPU} Reporting Settings. Processing of a CSI report occupies a number of CPUs, O_{CPU}, for a number of symbols as follows according 3GPP specification such as, for example, 3GPP 38.214:
O_{CPU}=0 for a CSI report with CSI-ReportConfig with higher layer parameter reportQuantity set to ‘none’ and CSI-RS-ResourceSet with higher layer parameter trs-Info configured
O_{CPU}=1 for a CSI report with CSI-ReportConfig with higher layer parameter reportQuantity set to ‘cri-RSRP’, ‘ssb-Index-RSRP’, ‘cri-SINR’, ‘ssb-Index-SINR’, ‘cri-RSRP-Index’, ‘ssb-Index-RSRP-Index’, ‘cri-SINR-Index’, ‘ssb-Index-SINR-Index’ or ‘none’ (and CSI-RS-ResourceSet with higher layer parameter trs-Info not configured)
for a CSI report with CSI-ReportConfig with higher layer parameter reportQuantity set to ‘cri-RI-PMI-CQI’, ‘cri-RI-i1’, ‘cri-RI-i1-CQI’, ‘cri-RI-CQI’, or ‘cri-RI-LI-PMI-CQI’,
O_{CPU}=N_{CPU} if max{μ_{PDCCH}, μ_{CSI-RS}, μ_{UL}}≤3, and if a CSI report is aperiodically triggered without transmitting a PUSCH with either transport block or HARQ-ACK or both when L=0 CPUs are occupied, where the CSI corresponds to a single CSI with wideband frequency-granularity and to at most 4 CSI-RS ports in a single resource without CRI report and where codebookType is set to ‘typeI-SinglePanel’ or where reportQuantity is set to ‘cri-RI-CQI’,
O_{CPU}=X·N+M If a CSI-ReportConfig is configured with codebookType set to ‘typeI-SinglePanel’ and the corresponding CSI-RS Resource Set for channel measurement is configured with two Resource Groups and N Resource Pairs, where X is the number of CPUs occupied by a pair of CMRs subject to UE capability given by mTRP-CSI-numCPU-r17 and M is defined in clause 5.2.1.4.2 of 3GPP 38.214 v17.5.0
O_{CPU}=KS otherwise, where KS is the number of CSI-RS resources in the CSI-RS resource set for channel measurement.

For a CSI report with CSI-ReportConfig with higher layer parameter reportQuantity not set to ‘none’, the CPU(s) are occupied for a number of OFDM symbols as follows:
A periodic or semi-persistent CSI report (excluding an initial semi-persistent CSI report on PUSCH after the PDCCH triggering the report) occupies CPU(s) from the first symbol of the earliest CSI-RS/CSI-IM/SSB resource in a CSI resource set for channel or interference measurement in a latest CSI-RS/CSI-IM/SSB occasion no later than the corresponding CSI reference resource, until the last symbol of the configured PUSCH/PUCCH carrying the report.
An aperiodic CSI report occupies CPU(s) from the first symbol after the PDCCH triggering the CSI report until the last symbol of the scheduled PUSCH carrying the report. When the PDCCH reception includes two PDCCH candidates from two respective search space sets, as described in 3GPP specification such as, for example, clause 10.1 of 3GPP TS 38.213, for the purpose of determining the CPU occupation duration, the PDCCH candidate that ends later in time is used.
An initial semi-persistent CSI report on PUSCH after the PDCCH trigger occupies CPU(s) from the first symbol after the PDCCH until the last symbol of the scheduled PUSCH carrying the report. When the PDCCH reception includes two PDCCH candidates from two respective search space sets, as described in 3GPP specification such as in, for example, clause 10.1 of 3GPP TS 38.213, for the purpose of determining the CPU occupation duration, the PDCCH candidate that ends later in time is used.

### Coherent Joint PDSCH Transmission Over Multiple TRPs

In NR Rel-18, coherent joint downlink transmission (CJT) from multiple TRPs will be supported by extending the Rel-16 enhanced and Rel-17 further enhanced type II codebooks across multiple TRPs.

In CJT, each layer is transmitted from multiple TRPs. An example is shown in FIG. 5, where data symbols of two layers are transmitted from two TRPs by applying two different precoding matrices at TRP1 and TRP2. The two precoders are designed such that for each layer, the signals received from the two TRPs are phase aligned at the wireless device and thus, are coherently combined.

For CSI reporting for CJT, multiple CSI-RS resources, each associated to a TRP, would be configured in a CSI-RS resource set for channel measurement and a CSI-IM resource may be configured for interference measurement

For CSI reporting for CJT, the wireless device measures the CSI across more than one NZP CSI-RS resources (e.g., each of the more than one CSI-RS resource associated with one TRP) for channel measurement. In addition, a wireless device may be configured with one or more hypotheses of beam combinations, i.e., the number of beams assumed for each of the multiple CSI-RS resources. However, the number of CPUs occupied for CJT CSI processing and the CPU occupation remained undefined in 3GPP specification.

### SUMMARY

Some embodiments advantageously provide methods, systems, and apparatuses for feedback reporting based on wireless device processing resources.

According to one aspect of the present disclosure, method(s) and apparatus(es) are described for determining the number CPUs for a CSI report for CJT configured with N_{TRP}≥1 NZP CSI-RS resources in a NZP CSI-RS resource set for channel measurement and N_{L}≥1 beam combination hypotheses, the method comprises:
Allocating Xᵢ (Xᵢ≥1 is an integer) CPUs for the i^{th} beam combination hypothesis, where Xᵢ can be either pre-determined based on the number of NZP CSI-RS resources, N_{TRP}, or reported by the wireless device as part of wireless device capability signaling. Xᵢ may be the same for all N_{L} hypotheses
Allocating additional Y (Y≥0) CPU(s) for other purpose such as for TRP selection or channel estimation, where Y may be a function of N_{TRP}, e.g., Y=N_{TRP}
Determining the total number of CPUs, O_{CPU}, for the CJT CSI report as

$${O}_{CPU} = {\sum }_{i = 1}^{{N}_{L}} {X}_{i} + Y .$$

According to one aspect of the present disclosure, a method implemented by a user equipment is provided. An indication received from a network node triggers a channel state information, CSI, report for coherent joint downlink transmission, CJT, where the CSI report is based on a plurality of CSI reference signal, CSI-RS, resources. A first number of CSI processing units, CPUs, required to process a CSI report is determined based at least on a number of the plurality of CSI-RS resources and a second number of CSI processing units required for each of the plurality of CSI-RS resources. The CSI report is processed based on the determined first number of CSI processing units. The CSI report is reported to the network node.

According to one or more embodiments of this aspect, the first number of CSI processing units is based on a multiplication of the number of the plurality of CSI-RS resources and the second number of CSI processing units.

According to one or more embodiments of this aspect, the second number of CSI processing units are required for channel estimation associated with each of the plurality of CSI-RS resources.

According to one or more embodiments of this aspect, the second number of CSI processing units is based on a number of CSI-RS ports for a CSI-RS resource.

According to one or more embodiments of this aspect, the first number of CSI processing units is further based on a third number of CSI processing units that are required for down-selecting at least one configured beam combination hypothesis.

According to one or more embodiments of this aspect, the third number of CSI processing units is equal to zero when the user equipment is not expected to perform down-selection.

According to one or more embodiments of this aspect, the first number of CSI processing units is further based on a fourth number of CSI processing units required for calculating a CSI for at least one down-selected configured beam combination hypothesis.

According to one or more embodiments of this aspect, the fourth number of CSI processing units is equal to zero when the user equipment is not expected to perform down-selection.

According to one or more embodiments of this aspect, prior to receiving the indication, a user equipment capability indicating the second number of CSI processing units is transmitted to the network node.

According to one or more embodiments of this aspect, the first number of CSI processing units is further based on a plurality of hypotheses of beam combinations, wherein each beam combination comprises a plurality number of beams associated with each of the plurality of CSI-RS resources.

According to one or more embodiments of this aspect, the CSI report comprises a rank indicator, RI, a precoding matrix indicator, PMI, and a channel quality indicator, CQI.

According to another aspect of the present disclosure, a user equipment is configured to: receive from a network node an indication triggering a channel state information, CSI, report for coherent joint downlink transmission, CJT, where the CSI report is based on a plurality of CSI reference signal, CSI-RS, resources, determine a first number of CSI processing units, CPUs, required to process a CSI report based at least on a number of the plurality of CSI-RS resources and a second number of CSI processing units required for each of the plurality of CSI-RS resources, process the CSI report based on the determined first number of CSI processing units, and report the CSI report to the network node.

According to one or more embodiments of this aspect, the first number of CSI processing units is based on a multiplication of the number of the plurality of CSI-RS resources and the second number of CSI processing units.

According to one or more embodiments of this aspect, the second number of CSI processing units are required for channel estimation associated with each of the plurality of CSI-RS resources.

According to one or more embodiments of this aspect, the second number of CSI processing units is based on a number of CSI-RS ports for a CSI-RS resource.

According to one or more embodiments of this aspect, the first number of CSI processing units is further based on a third number of CSI processing units that are required for down-selecting at least one configured beam combination hypothesis.

According to one or more embodiments of this aspect, the third number of CSI processing units is equal to zero when the user equipment is not expected to perform down-selection.

According to one or more embodiments of this aspect, the first number of CSI processing units is further based on a fourth number of CSI processing units required for calculating a CSI for at least one down-selected configured beam combination hypothesis.

According to one or more embodiments of this aspect, the fourth number of CSI processing units is equal to zero when the user equipment is not expected to perform down-selection.

According to one or more embodiments of this aspect, the user equipment is further configured to transmit to the network node, prior to receiving the indication, a user equipment capability indicating the second number of CSI processing units.

According to one or more embodiments of this aspect, the first number of CSI processing units is further based on a plurality of hypotheses of beam combinations, wherein each beam combination comprises a plurality number of beams associated with each of the plurality of CSI-RS resources.

According to one or more embodiments of this aspect, the CSI report comprises a rank indicator, RI, a precoding matrix indicator, PMI, and a channel quality indicator, CQI.

According to another aspect of the present disclosure, a method implemented by a network node is provided. A first number of channel state information, CSI, processing units required for a user equipment to process a CSI report for coherent joint downlink transmission, CJT, is determined where the first number of CSI processing units is based on a plurality of CSI reference signal, CSI-RS, resources configured for the CSI report and a second number of CSI processing units required for each of the plurality of CSI-RS resources. A determination is made to trigger a CSI report from the user equipment based at least on the determination of the first number of CSI processing units.

According to one or more embodiments of this aspect, the second number of CSI processing units is determined where the second number of CSI processing units is required for channel estimation associated with each of the plurality of CSI-RS resources.

According to one or more embodiments of this aspect, the second number of CSI processing units is based on a number of CST-RS ports for a CST-RS resource.

According to one or more embodiments of this aspect, a third number of CSI processing units required for down-selecting at least one configured beam combination hypotheses is determined.

According to one or more embodiments of this aspect, the third number is equal to zero when the user equipment is not expected to perform down-selection.

According to one or more embodiments of this aspect, a fourth number of CSI processing units required for calculating a CSI for at least one down-selected configured beam combination hypothesis is determined.

According to one or more embodiments of this aspect, the fourth number is equal to zero when the user equipment is not expected to perform down-selection.

According to one or more embodiments of this aspect, prior to the determining to trigger the CSI report, a capability indicating the second number of CSI processing units is received from the user equipment.

According to one or more embodiments of this aspect, the CSI report comprises a rank indicator, RI, a precoding matrix indicator, PMI, and a channel quality indicator, CQI.

According to another aspect of the present disclosure, a network node is configured to determine first number of channel state information, CSI, processing units required for a user equipment to process a CSI report for coherent joint downlink transmission, CJT, where the first number of CSI processing units is based on a plurality of CSI reference signal, CSI-RS, resources configured for the CSI report and a second number of CSI processing units required for each of the plurality of CSI-RS resources, and determine to trigger a CSI report from the user equipment based at least on the determination of the first number of CSI processing units.

According to one or more embodiments of this aspect, the network node is further configured to determine the second number of CSI processing units, the second number of CSI processing units being required for channel estimation associated with each of the plurality of CSI-RS resources.

According to one or more embodiments of this aspect, the second number of CSI processing units is based on a number of CSI-RS ports for a CSI-RS resource.

According to one or more embodiments of this aspect, the network node is further configured to determine a third number of CSI processing units required for down-selecting at least one configured beam combination hypotheses.

According to one or more embodiments of this aspect, the third number is equal to zero when the user equipment is not expected to perform down-selection.

According to one or more embodiments of this aspect, the network node is further configured to determine a fourth number of CSI processing units required for calculating a CSI for at least one down-selected configured beam combination hypothesis.

According to one or more embodiments of this aspect, the fourth number is equal to zero when the user equipment is not expected to perform down-selection.

According to one or more embodiments of this aspect, the network node is further configured to receive from the user equipment, prior to the determining to trigger the CSI report, a capability indicating the second number of CSI processing units.

According to one or more embodiments of this aspect, the CSI report comprises a rank indicator, RI, a precoding matrix indicator, PMI, and a channel quality indicator, CQI.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a block diagram of a NR time-domain structure with 15 kHz subcarrier spacing;

FIG. 2 is a block diagram of a NR physical resource grid;

FIG. 3 is a block diagram of a transmission structure of spatial multiplexing in NR;

FIG. 4 is a block diagram of an example of RE allocation for a 12-port CSI-RS in NR;

FIG. 5 is a block diagram of an example of CJT over two TRPs;

FIG. 6 is a schematic diagram of an example network architecture illustrating a communication system connected via an intermediate network to a host computer according to the principles in the present disclosure;

FIG. 7 is a block diagram of a host computer communicating via a network node with a wireless device over an at least partially wireless connection according to some embodiments of the present disclosure;

FIG. 8 is a flowchart illustrating example methods implemented in a communication system including a host computer, a network node and a wireless device for executing a client application at a wireless device according to some embodiments of the present disclosure;

FIG. 9 is a flowchart illustrating example methods implemented in a communication system including a host computer, a network node and a wireless device for receiving user data at a wireless device according to some embodiments of the present disclosure;

FIG. 10 is a flowchart illustrating example methods implemented in a communication system including a host computer, a network node and a wireless device for receiving user data from the wireless device at a host computer according to some embodiments of the present disclosure;

FIG. 11 is a flowchart illustrating example methods implemented in a communication system including a host computer, a network node and a wireless device for receiving user data at a host computer according to some embodiments of the present disclosure;

FIG. 12 is a flowchart of an example process in a network node according to some embodiments of the present disclosure;

FIG. 13 is a flowchart of another example process in a network node according to some embodiments of the present disclosure;

FIG. 14 is a flowchart of an example process in a UE according to some embodiments of the present disclosure;

FIG. 15 is a flowchart of another example process in a UE according to some embodiments of the present disclosure;

FIG. 16 is a block diagram of an example of CJT for multiple TRPs with beam combining precoders feedback from a wireless device;

FIG. 17 is a block diagram of an example of the CPU duration for aperiodic CJT CSI report; and

FIG. 18 is a block diagram of an example of the CPU duration for semi-persistent CJT CSI report.

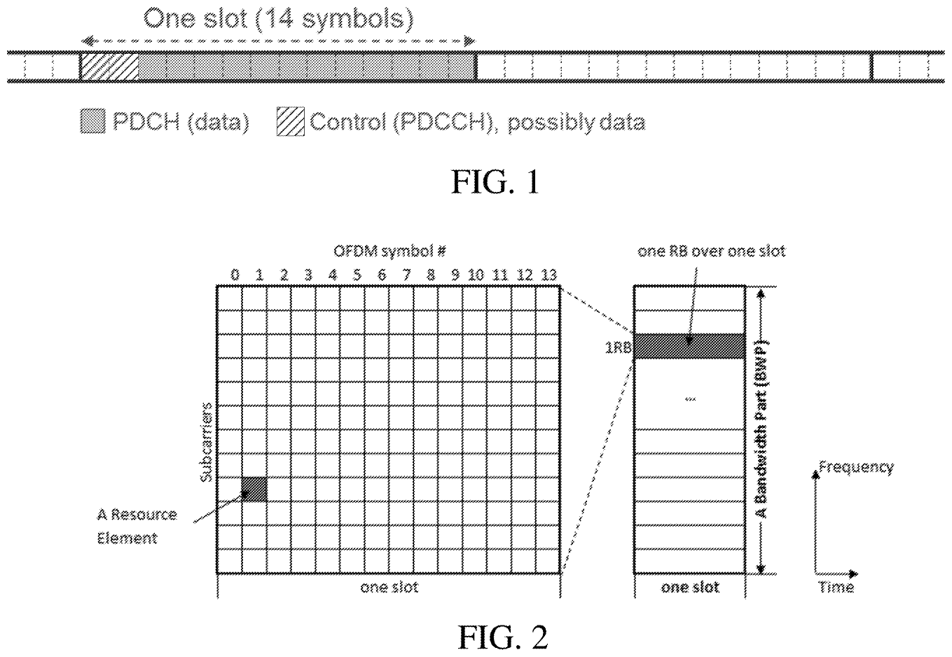

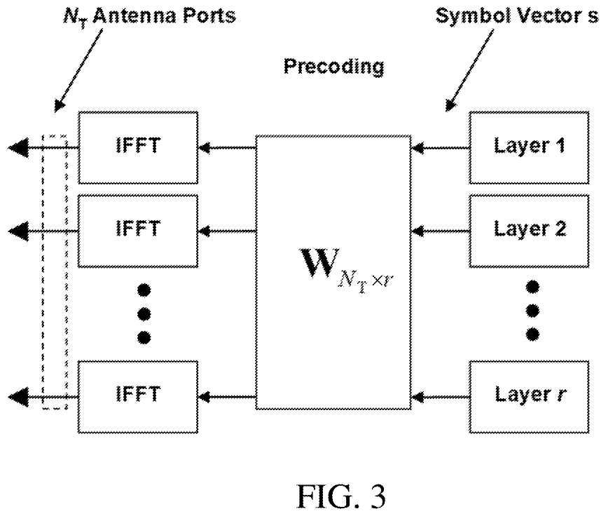

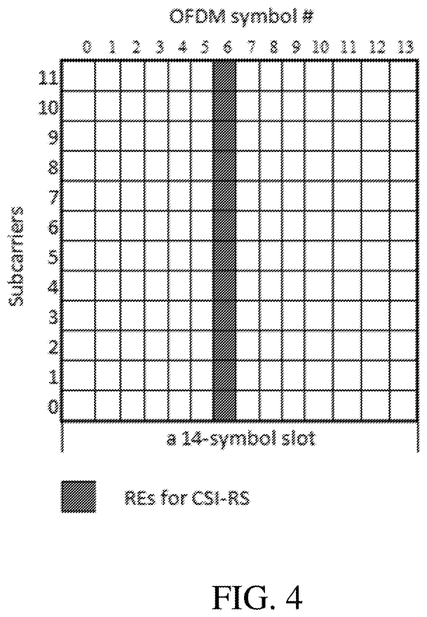

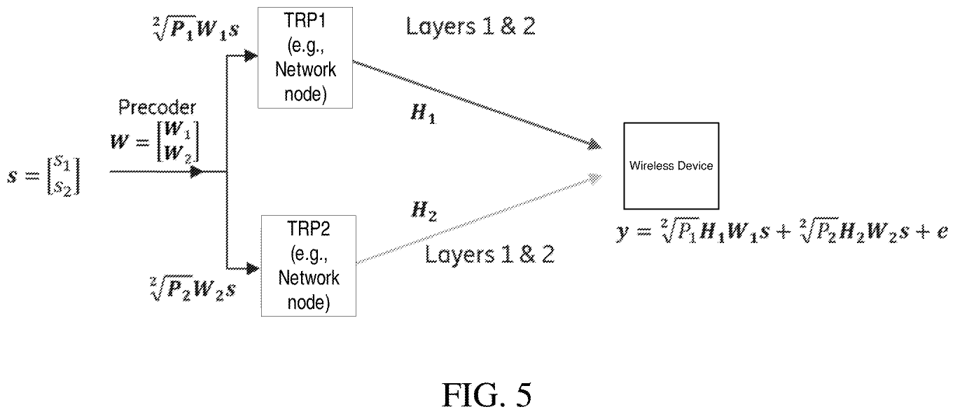

### DETAILED DESCRIPTION

Before describing in detail example embodiments, it is noted that the embodiments reside primarily in combinations of apparatus components and processing steps related to feedback reporting based on wireless device processing resources. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD and UE herein can be any type of wireless device capable of communicating with a network node or another WD/UE over radio signals. The WD/UE may also be a radio communication device, target device, device to device (D2D) WD/UE, machine type WD/UE or WD/UE capable of machine to machine communication (M2M), low-cost and/or low-complexity WD/UE, a sensor equipped with WD/UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide feedback reporting based on wireless device processing resources.

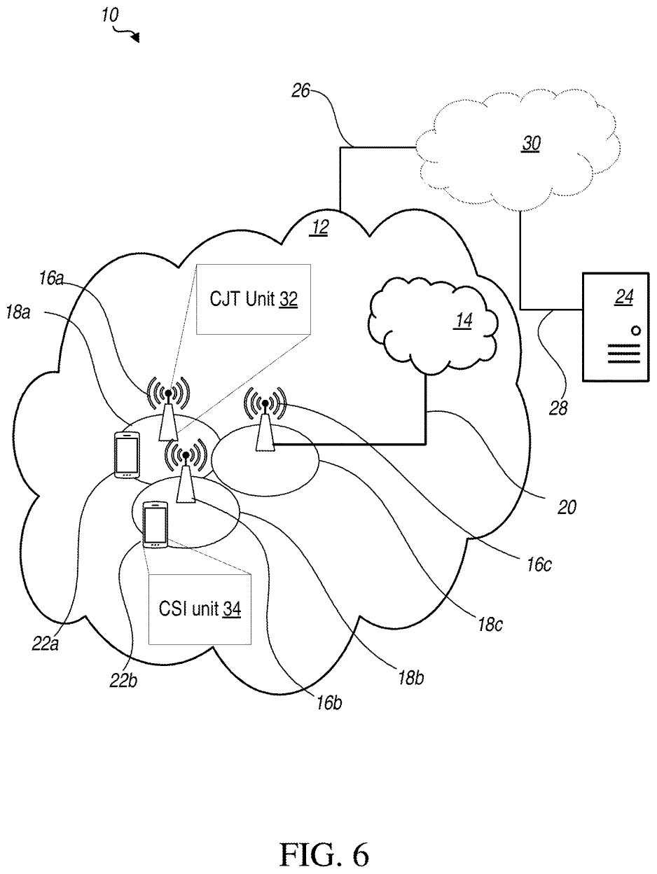

Referring again to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a CJT unit 32 which is configured to perform one or more network node 16 functions described herein such as, for example, with respect to feedback reporting based on wireless device processing resources. A wireless device 22 is configured to include a CSI unit 34 which is configured to perform one or more wireless device 22 functions as described herein such as with respect to feedback reporting based on wireless device processing resources.

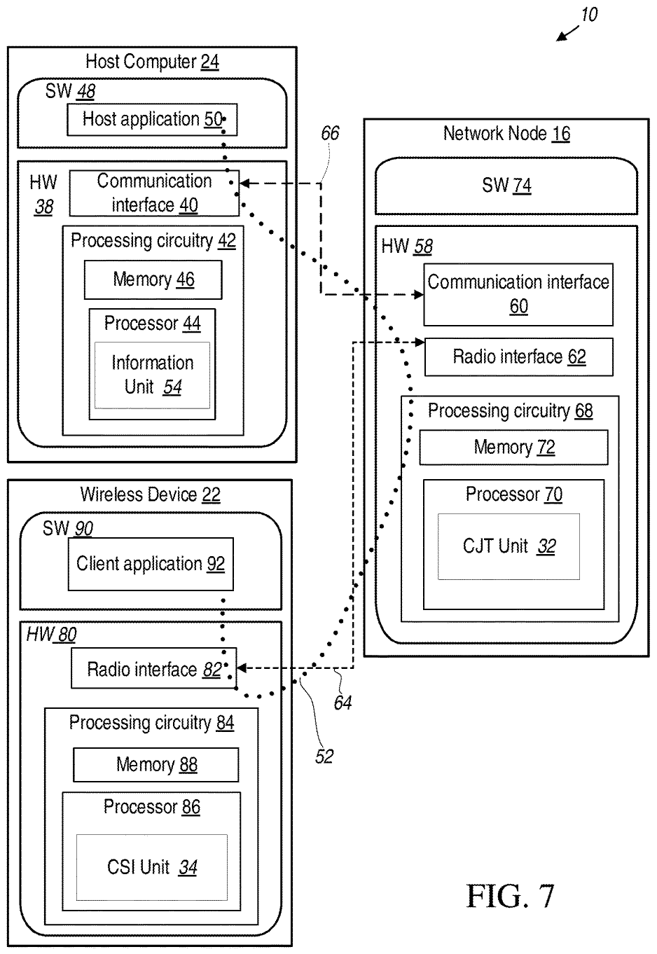

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of process, analyze, store, forward, relay, transmit, receive, etc. information related to feedback reporting based on wireless device processing resources.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include CJT unit 32 configured perform one or more network node 16 functions as described herein such as with respect to, for example, feedback reporting based on wireless device processing resources.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a CSI unit 34 configured to perform one or more wireless device 22 functions as described herein such as with respect to feedback reporting based on wireless device processing resources.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as CJT unit 32, and CSI unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

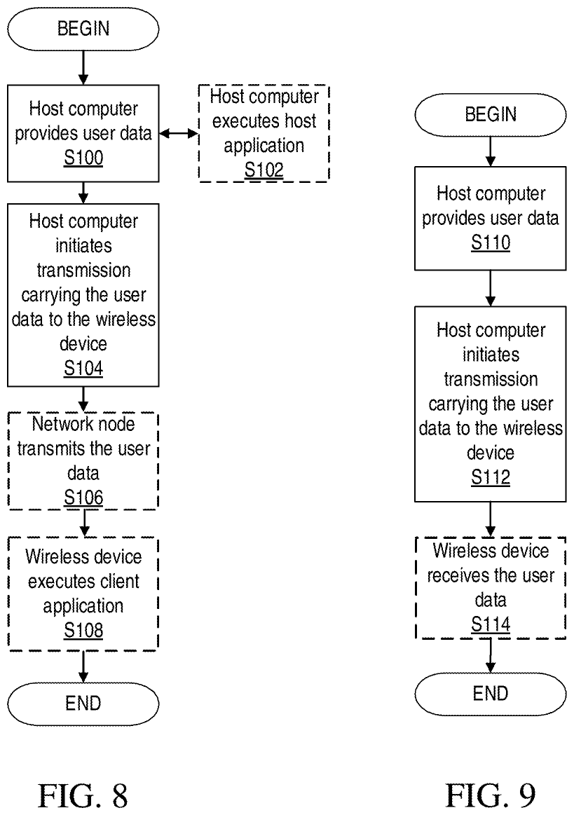

FIG. 8 is a flowchart illustrating an example method implemented in a communication system, such as, for example, the communication system of FIGS. 6 and 7, in accordance with one embodiment. The communication system may include a host computer 24, a network node 16 and a WD 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 9 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

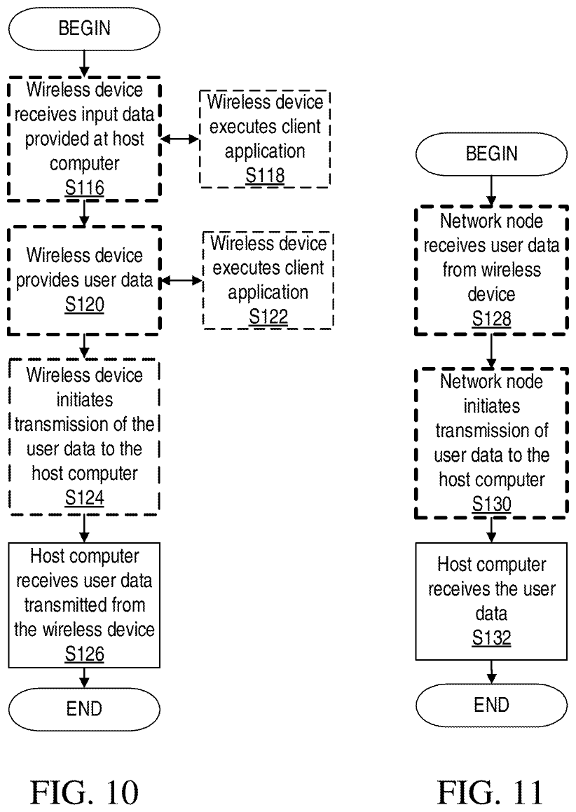

FIG. 10 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 11 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

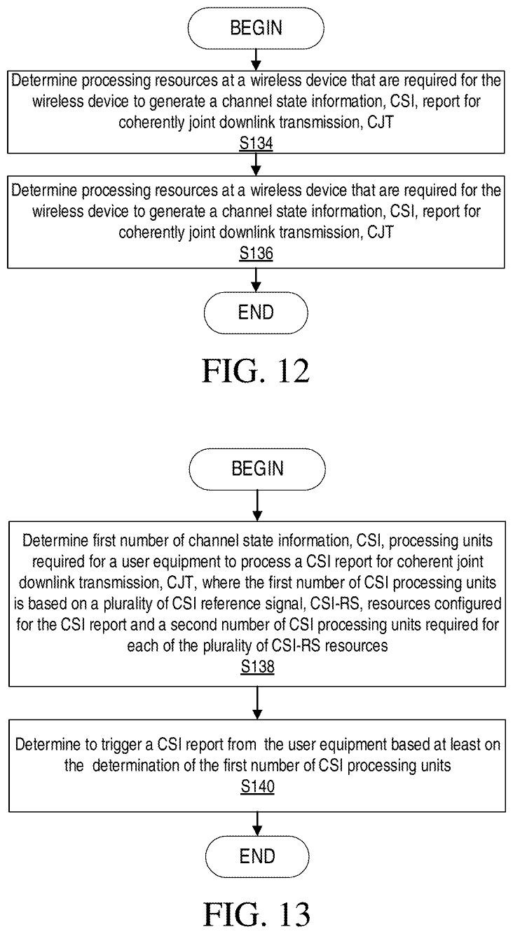

FIG. 12 is a flowchart of an example process in a network node 16 according to the present disclosure. One or more blocks described herein may be performed by one or more elements of network node 16 such as by one or more of processing circuitry 68 (including the CJT unit 32), processor 70, radio interface 62 and/or communication interface 60. Network node 16 is configured to determine (Block S134) processing resources at a wireless device 22 that are required for the wireless device 22 to generate a channel state information, CSI, report for coherently joint downlink transmission, CJT, as described herein. Network node 16 is configured to determine (Block S136) processing resources at a wireless device 22 that are required for the wireless device 22 to generate a channel state information, CSI, report for coherently joint downlink transmission, CJT, as described herein.

According to one or more embodiments, the determining of processing resources corresponds to determining a number of central processing units, CPUs.

According to one or more embodiments, the CJT is configured with N_{TRP} NZP CSI-RS resources in a NZP CSI-RS resource set for channel measurement and N_{L} beam combination hypotheses, where N_{TRP} is an integer and N_{L} is an integer.

According to one or more embodiments, the determining of processing resources (O_{CPU}) is based on at least one of:

$${O}_{CPU} = {\sum }_{i = 1}^{{N}_{L}} {X}_{i} ,$$

where Xᵢ is the number of processing resources for the ith hypothesis;
O_{CPU}=XN_{L}, where X is number of processing resources for each of hypotheses;

$${O}_{CPU} = {\sum }_{i = 1}^{{N}_{L}} {X}_{i} + Y ,$$

where Y≥0 is an integer;
O_{CPU}=XN_{L}+Y, where Y≥0 is an integer; and
O_{CPU}=┌γN_{L}+KN_{TRP},┐, where γ is a scaling factor and K is the processing resources for each of the NZP CSI-RS resources.

According to one or more embodiments, the processing circuitry 68 is further configured to receive wireless device capability of the wireless device 22, where the wireless device capability indicating a number of processing resources required for each N_{L} hypotheses across the N_{TRP} CSI-RS resources.

According to one or more embodiments, the processing circuitry 68 is further configured to: determine processing resources durations that are required for the wireless device 22 to generate the CSI report for CJT, the determining of whether to trigger the CSI report at the wireless device 22 being based at least on the determined processing resources durations.

According to one or more embodiments, the processing circuitry 68 is further configured to: trigger the CSI report at the wireless device 22 based on the determination of whether to trigger the CSI report; and receive the CSI report from the wireless device 22.

FIG. 13 is a flowchart of an example process in a network node 16 according to the present disclosure. One or more blocks described herein may be performed by one or more elements of network node 16 such as by one or more of processing circuitry 68 (including the CJT unit 32), processor 70, radio interface 62 and/or communication interface 60. Network node 16 is configured to determine (Block S138) first number of channel state information, CSI, processing units required for a user equipment (22) to process a CSI report for coherent joint downlink transmission, CJT, where the first number of CSI processing units is based on a plurality of CSI reference signal, CSI-RS, resources configured for the CSI report and a second number of CSI processing units required for each of the plurality of CSI-RS resources, as described herein. Network node 16 is configured to determine (Block S140) to trigger a CSI report from the user equipment (22) based at least on the determination of the first number of CSI processing units, as described herein.

According to one or more embodiments, network node 16 is further configured to determine the second number of CSI processing units, where the second number of CSI processing units is required for channel estimation associated with each of the plurality of CSI-RS resources.

According to one or more embodiments, the second number of CSI processing units is based on a number of CSI-RS ports for a CSI-RS resource.

According to one or more embodiments, network node 16 is further configured to determine a third number of CSI processing units required for down-selecting at least one configured beam combination hypotheses.

According to one or more embodiments, the third number is equal to zero when the user equipment 22 is not expected to perform down-selection.

According to one or more embodiments, network node 16 is further configured to determine a fourth number of CSI processing units required for calculating a CSI for at least one down-selected configured beam combination hypothesis.

According to one or more embodiments, the fourth number is equal to zero when the user equipment 22 is not expected to perform down-selection.

According to one or more embodiments, network node 16 is further configured to receive from the user equipment 22, prior to the determining to trigger the CSI report, a capability indicating the second number of CSI processing units.

According to one or more embodiments, the CSI report comprises a rank indicator, RI, a precoding matrix indicator, PMI, and a channel quality indicator, CQI.

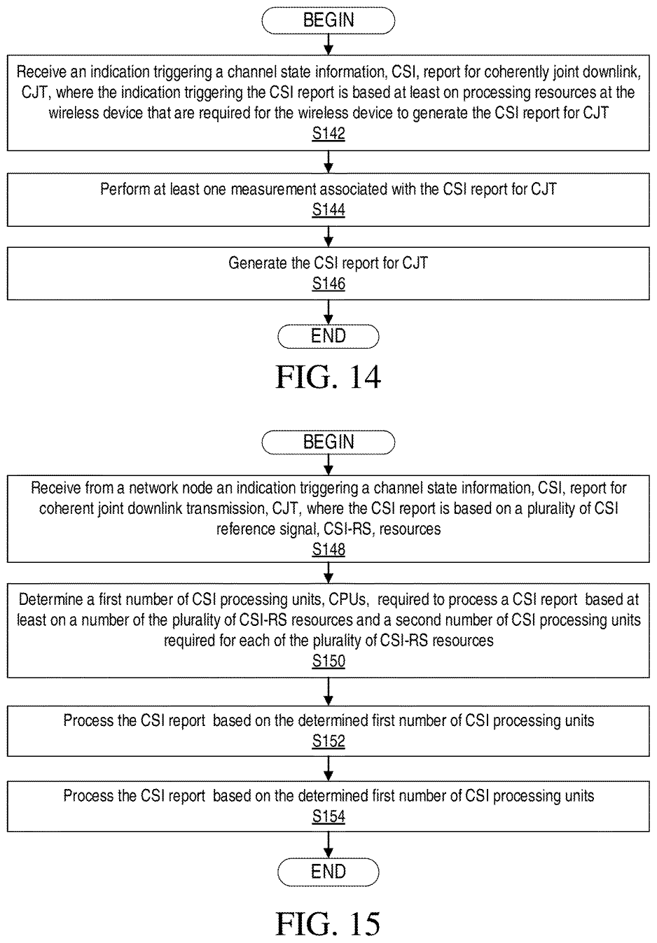

FIG. 14 is a flowchart of an example process in a wireless device 22 (e.g., UE 22) according to some embodiments of the present. One or more blocks described herein may be performed by one or more elements of wireless device 22 such as by one or more of processing circuitry 84 (including the CSI unit 34), processor 86, radio interface 82 and/or communication interface 60. Wireless device 22 is configured to receive (Block S138) an indication triggering a channel state information, CSI, report for coherently joint downlink, CJT, where the indication triggering the CSI report is based at least on processing resources at the wireless device 22 that are required for the wireless device 22 to generate the CSI report for CJT, as described herein. Wireless device 22 is configured to perform (Block S140) at least one measurement associated with the CSI report for CJT, as described herein. Wireless device 22 is configured to generate (Block S142) the CSI report for CJT, as described herein.

According to some embodiments, the processing resources correspond to a number of central processing units, CPUs.

According to some embodiments, the CJT is configured with N_{TRP} NZP CSI-RS resources in a NZP CSI-RS resource set for channel measurement and N_{L} beam combination hypotheses, where N_{TRP} is an integer and N_{L} is an integer.

According to some embodiments, the processing resources (O_{CPU}) are based on at least one of:

$${O}_{CPU} = {\sum }_{i = 1}^{{N}_{L}} {X}_{i} ,$$

where Xᵢ is the number of processing resources for the ith hypothesis;
O_{CPU}=XN_{L}, where X is number of processing resources for each of hypotheses;

$${O}_{CPU} = {\sum }_{i = 1}^{{N}_{L}} {X}_{i} + Y ,$$

where Y≥0 is an integer;
O_{CPU}=XN_{L}+Y, where Y≥0 is an integer; and
O_{CPU}=┌γN_{L}+KN_{TRP},┐, where γ is a scaling factor and K is the processing resources for each of the NZP CSI-RS resources.

According to some embodiments, the processing circuitry 84 is further configured to cause transmission of wireless device capability of the wireless device 22, where the wireless device capability indicating a number of processing resources required for each N_{L} hypotheses across the N_{TRP} CSI-RS resources.

According to some embodiments, the indication triggering the CSI report is based at least on the processing resources durations that are required for the wireless device 22 to generate the CSI report for CJT.

FIG. 15 is a flowchart of another example process in a UE 22 according to some embodiments of the present. One or more blocks described herein may be performed by one or more elements of UE 22 such as by one or more of processing circuitry 84 (including the CSI unit 34), processor 86, radio interface 82 and/or communication interface 60. UE 22 is configured to receive (Block S148) from a network node (16) an indication triggering a channel state information, CSI, report for coherent joint downlink transmission, CJT, where the CSI report is based on a plurality of CSI reference signal, CSI-RS, resources, as described herein. UE 22 is configured to determine (Block S150) a first number of CSI processing units, CPUs, required to process a CSI report based at least on a number of the plurality of CSI-RS resources and a second number of CSI processing units required for each of the plurality of CSI-RS resources, as described herein. UE 22 is configured to process (Block S152) the CSI report based on the determined first number of CSI processing units, as described herein. Network node 16 is configured to report (Block S154) the CSI report to the network node 16, as described herein.

According to one or more embodiments, the first number of CSI processing units is based on a multiplication of the number of the plurality of CSI-RS resources and the second number of CSI processing units.

According to one or more embodiments, the second number of CSI processing units are required for channel estimation associated with each of the plurality of CSI-RS resources.

According to one or more embodiments, the second number of CSI processing units is based on a number of CSI-RS ports for a CSI-RS resource.

According to one or more embodiments, the first number of CSI processing units is further based on a third number of CSI processing units that are required for down-selecting at least one configured beam combination hypothesis.

According to one or more embodiments, the third number of CSI processing units is equal to zero when the user equipment is not expected to perform down-selection.

According to one or more embodiments, the first number of CSI processing units is further based on a fourth number of CSI processing units required for calculating a CSI for at least one down-selected configured beam combination hypothesis.

According to one or more embodiments, the fourth number of CSI processing units is equal to zero when the user equipment is not expected to perform down-selection.

According to one or more embodiments, UE 22 is further configured to transmit to the network node 16, prior to receiving the indication, a UE capability indicating the second number of CSI processing units.

According to one or more embodiments, the first number of CSI processing units is further based on a plurality of hypotheses of beam combinations, wherein each beam combination comprises a plurality number of beams associated with each of the plurality of CSI-RS resources.

According to one or more embodiments, the CSI report comprises a rank indicator, RI, a precoding matrix indicator, PMI, and a channel quality indicator, CQI.

According to one or more embodiments, the UE 22 and the network node 16 may have to each determine the first number of CPUs so that both the UE 22 and the network node 16 have the same understanding and/or knowledge of the first number of CPUs.

Having described the general process flow of arrangements of the disclosure and having provided examples of hardware and software arrangements for implementing the processes and functions of the disclosure, the sections below provide details and examples of arrangements for feedback reporting based on wireless device processing resources.

Some embodiments provide feedback reporting based on wireless device processing resources. One or more network node 16 functions described below may be performed by one or more of processing circuitry 68, CJT unit 32, processor 70, radio interface 62, etc. One or more wireless device 22 functions described below may be performed by one or more of processing circuitry 84, processor 86, CSI unit 34, radio interface 82, etc. In one or more embodiments, a network node 16 may correspond to one or more TRPs.

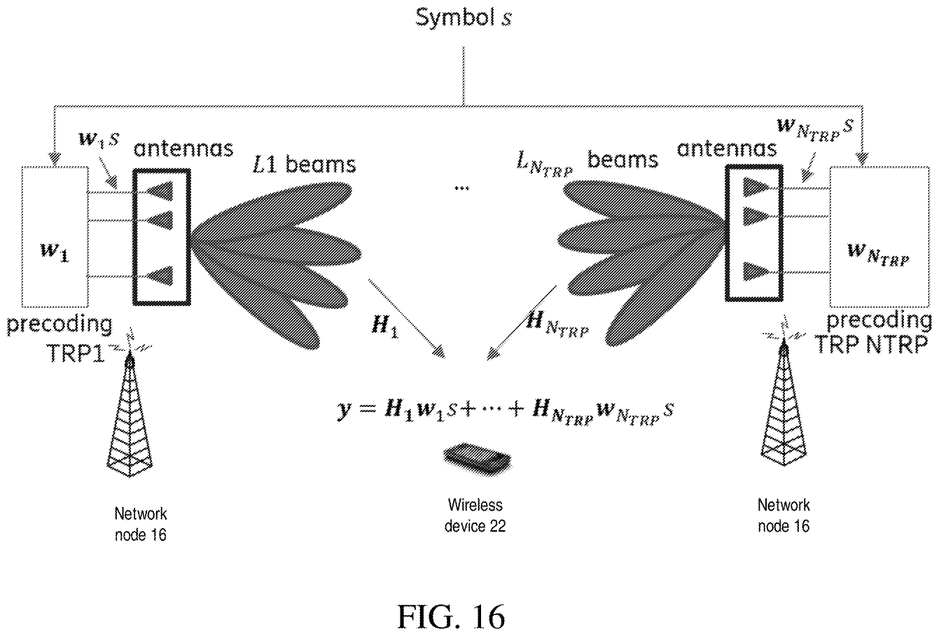

An example of Coherent Joint Transmission (CJT) over multiple TRPs is illustrated in FIG. 16, where a modulation symbol s is transmitted over multiple TRPs. Before transmission, the modulation symbol is precoded at each TRP and the precoded symbol is then transmitted over the antennas at each TRP. The precoders are used to ensure that the symbol is coherently combined at the wireless device 22. Each precoder consists of a combination of multiple spatial domain (SD) DFT vectors (or beams). The SD vectors and the combining coefficients are selected and reported by a wireless device 22 as part of CJT CSI feedback based on measurements of the DL channels across all the TRPs. The measurements are performed over multiple NZP CSI-RS resources each transmitted from one of the TRPs.

For symbols transmitted in different subbands, different precoders may be used. Also, different precoders are used for symbols belonging to different MIMO layers. A CJT precoding matrix W^{l} for layer l (l=1, . . . , v) over N₃ PMI subbands and N_{TRP} TRPs (or NZP CSI-RS resources) can be expressed as

$${W}^{l} = [ \begin{matrix}{W}_{1}^{l} \\ {W}_{2}^{l} \\ … \\ {W}_{{N}_{TRP}}^{l}\end{matrix} ] \qquad Eq . l$$

$$where {W}_{n}^{l} ( = 1 , … , {N}_{TRP} )$$

is the precoding matrix associated to the nth NZP CSI-RS resource (or TRP) and is given by

$${W}_{n}^{l} = [ {w}_{l , n}^{( 0 )} … {w}_{l , n}^{( {N}_{3} - 1 )} ] = {W}_{1 , n} {\tilde{W}}_{2 , l , n} {W}_{f , l , n}^{H} \qquad Eq . 2$$

$$where {w}_{l , n}^{( t )}$$

is a P_{CSI-Rs,n}×1 precoding vector associated to the nth CSI-RS resource at PMI subband t∈{0, 1, . . . , N₃−1} for layer l, where P_{CSI-Rs,n}=2N_{1,n}N_{2,n} is the number of CSI-RS ports in the n^{th} NZP CSI-RS resource, and N_{1,2} and N_{2,n} are the number of antenna ports in a first and a second dimension, respectively. The number of CSI-RS ports in different NZP CSI-RS resources can be the same or different.

$${W}_{1 , n} = [ \begin{matrix}{v}_{{m}_{1 , n}^{( 0 )} , {m}_{2 , n}^{( 0 )}}^{( n )} , … , {v}_{{m}_{1 , n}^{( {L}_{n} - 1 )} , {m}_{2 , n}^{( {L}_{n} - 1 )}}^{( n )} & 0 \\ 0 & {v}_{{m}_{1 , n}^{( 0 )} , {m}_{2 , n}^{( 0 )}}^{( n )} , … , {v}_{{m}_{1 , n}^{( {L}_{n} - 1 )} , {m}_{2 , n}^{( {L}_{n} - 1 )}}^{( n )}\end{matrix} ]$$

is a size P_{CSI-RS,n}×2Lₙ matrix associated with the nth NZP CSI-RS resource, where Lₙ is the number of beams configured for the nth NZP CSI-RS resource and

$$\{ {v}_{{m}_{1 , n}^{( 0 )} , {m}_{2 , n}^{( 0 )}}^{( n )} , … , {v}_{{m}_{1 , n}^{( {L}_{n} - 1 )} , {m}_{2 , n}^{( {L}_{n} - 1 )}}^{( n )} \}$$

are Lₙ selected 2-D spatial DFT vectors or beams by the UE:

$${v}_{{m}_{1 , n}^{( i )} , {m}_{2 , n}^{( i )}}^{( n )} = [ {u}_{{m}_{2 , n}^{( i )}}^{( n )} {e}^{j \frac{2 π {m}_{1 , n}^{( i )}}{{O}_{1 , n} {N}_{1 , n}}} {u}_{{m}_{2 , n}^{( i )}}^{( n )} … {e}^{j \frac{2 π {m}_{1 , n}^{( i )} ( {N}_{1 , n} - 1 )}{{O}_{1 , n} {N}_{1 , n}}} {u}_{{m}_{2 , n}^{( i )}}^{( n )} ] , where$$

$${u}_{{m}_{2 , n}^{( i )}}^{( n )} = {[ 1 {e}^{j \frac{2 π {m}_{2 n}^{( i )}}{{O}_{2 , n} {N}_{2 , n}}} … {e}^{j \frac{2 π {m}_{2 , n}^{( i )} ( {N}_{2 , n} - 1 )}{{O}_{2 , n} {N}_{2 , n}}} ]}^{T} if {N}_{2 , n} > 1 and {u}_{{m}_{2 , n}^{( i )}}^{( n )} = 1$$

$$if {N}_{2 , n} = 1 , {m}_{1 , n}^{( i )} = {O}_{1 , n} {n}_{1 , n}^{( i )} + {q}_{1 , n} , {m}_{2 , n}^{( i )} = {O}_{2 , n} {n}_{2 , n}^{( i )} + {q}_{2 , n} ,$$

$${n}_{1 , n}^{( i )} ∈ \{ 0 , 1 , … , {N}_{1 , n} - 1 \} , {n}_{2 , n}^{( i )} ∈ \{ 0 , 1 , … , {N}_{2 , n} - 1 \} ,$$

$${q}_{1 , n} ∈ \{ 0 , 1 , … , {O}_{1 , n} - 1 \} , {q}_{2 , n} ∈ \{ 0 , 1 , … , {O}_{2 , n} - 1 \} , i = 0 , 1 , … {L}_{n} - 1 ,$$

and O_{1,n} and O_{2,n} are the oversampling factors along dimensions of N_{1,n} and N_{2,n}, respectively.

$${W}_{f , l , n} = ⌈ {y}_{l , n}^{( 0 )} , {y}_{l , n}^{( 1 )} , … , {y}_{l , n}^{( {M}_{v , n} - 1 )} ]$$

is a size N₃×M_{v,n} frequency domain (FD) compression matrix comprising M_{v,n} basis vectors associated to the n^{th} CSI-RS resource, where

$${y}_{l , n}^{( f )} ∈ \{ {y}_{0} {y}_{1} … {y}_{{N}_{3} - 1} \} , and {y}_{k} = {[ {y}_{k , 0} , {y}_{k , 1} , … , {y}_{k , {N}_{3} - 1} ]}^{T} and$$

$${y}_{k , t} = {e}^{- j 2 π kt / {N}_{3}} , k , t = 0 , 1 , … , {N}_{3} - 1.$$

$${\tilde{W}}_{2 , l , n} = [ {c}_{l , i , f , p , n} , i = 0 , 1 , … , 2 {L}_{n} - 1 ; f = 0 , 1 , … , {M}_{v , n} - 1 ; p = 0 , 1 ]$$

is a size 2Lₙ×M_{v,n} coefficient matrix associated to the n^{th} CSI-RS resource.

In an alternative expression, each of the precoding vector

$${w}_{l , n}^{( t )}$$

can be expressed as follows:

$${w}_{l , n}^{( t )} = [ \begin{matrix}{w}_{l , 0 , n}^{( t )} \\ {w}_{l , 1 , n}^{( t )}\end{matrix} ] , n = 1 , … , {N}_{TRP} . \qquad Eq . 3$$

$${w}_{l , p , n}^{( t )} = {\sum }_{i = 0}^{{L}_{n} - 1} {v}_{{m}_{1 , n}^{( i )} , {m}_{2 , n}^{( i )}}^{( n )} {\sum }_{f = 0}^{{M}_{v , n} - 1} {c}_{l , i , f , p , n} {y}_{t , l , n}^{( f )} , p = 0 , 1 \qquad Eq . 4$$

$${y}_{t , l , n}^{( f )} = {e}^{j \frac{2 π {tn}_{3 , l , n}^{( f )}}{{N}_{3}}} \qquad Eq . 5$$

$${c}_{l , i , f , p , n} = {p}_{l , p , n}^{( 1 )} {p}_{l , i , f , p , n}^{( 2 )} {φ}_{l , i , f , p , n} \qquad Eq . 6$$

$$where {w}_{l , n}^{( t )}$$

consists of two parts,

$${w}_{l , 0 , n}^{( t )}$$

for a first polarization and

$${w}_{l , 1 , n}^{( t )}$$

for a second polarization,

$${n}_{3 , l , n}^{( f )} ∈ \{ 0 , 1 , … , {N}_{3} - 1 \}$$

is a FD basis vector index of the f^{th} selected FD basis vector associated to the nth CSI-RS resource,

$${c}_{l , i , f , p , n} = {p}_{l , p , n}^{( 1 )} {p}_{l , i , f , p , n}^{( 2 )} {φ}_{l , i , f , p , n}$$

is the coefficient of \tilde{W}_{2,l,n} associated with layer l, the i^{th} beam, the f^{th} FD basis vector, the p^{th} polarization, and the n^{th} CSI-RS resource;

$${p}_{l , p , n}^{( 1 )}$$

is the reference amplitude associated with layer l, polarization index p, and CSI-RS resource index n, and

$${p}_{l , i , f , p , n}^{( 2 )}$$

is the amplitude with respect to

$${p}_{l , p , n}^{( 1 )}$$

associated with layer l, the i^{th} selected spatial beam, the f^{th} selected FD basis vector, the p^{th} polarization, and the n^{th}CSI-RS resource. φ_{l,i,f,p,n} is the co-phase factor associated to coefficient c_{l,i,f,p,n}.

Note that wireless device 22 may select N (N≤N_{TRP}) out of the N_{TRP} configured CSI-RS resources or TRPs and report W^{l} based on the N selected CSI-RS resources or TRPs. In that case, W^{l} contains precoding matrices associated to the N selected TRPs.

### Determining the Number of CPUs Required for a CJT CSI Report:

For a CSI report configured for CJT with N_{TRP}≥1 NZP CSI-RS resources in a NZP CSI-RS resource set for channel measurement (CMR) and with N_{L}≥1 hypotheses of beam combinations, where the ith (i=1, . . . , N_{L}) hypothesis consists of {L₁(i), L₂(i), . . . , L_{N}_{_{TRP}}(i)}, where Lₙ(i) (n=1, . . . , N_{TRP}) is the number of beams associated to the nth NZP CSI-RS resource, in one embodiment the total number of CSI processing units (CPUs), O_{CPU}, required for processing the CJT CSI report is determined as one or more of:

O_{CPU}=XN_{L} where X is the number of CPUs required for each of the N_{L} hypotheses across all the N_{TRP} NZP CSI-RS resources. In one embodiment, X can be a function of the number of NZP CSI-RS resources for channel measurement, i.e., X=f(N_{TRP}). For example, X=N_{TRP}. In another embodiment, X may be either pre-determined (e.g., defined in 3GPP specification and is known by both the network node 16 and the wireless device 22) or may be reported to the network node 16 by a wireless device 22 as part of wireless device capability signaling.

O_{CPU} is needed at both the network node 16 and the wireless device 22. For a given maximum number of CPUs supported by the wireless device 22, O_{CPU} is used by the network node 16 to determine whether the wireless device 22 has enough CPUs to process the CJT CSI report and thus, whether to trigger the CSI report. If the CSI report is triggered while the wireless device 22 does not have enough CPUs, the wireless device 22 would not update the CSI report or may report a stalled CSI.

An example of CPU allocations with N_{TRP}=4, N_{L}=2, and X=N_{TRP} is shown in Table 1, where O_{CPU}=4*2=8 CPUs are required.

TABLE 1
An example of CPU allocation with N_{TRP} =
4, N_{L} = 2, and X = N_{TRP}.

| | |
|---|---|
| Hypotheses of beam | |
| combination | CSI-RS resources |

| {L1, L2, L3, L4} | #1 | #2 | #3 | #4 |
|---|---|---|---|---|
| {2, 2, 2, 2} | CPU#1 | CPU#2 | CPU#3 | CPU#4 |
| {4, 4, 4, 4} | CPU#5 | CPU#6 | CPU#7 | CPU#8 |

Another example of CPU allocation with N_{TRP}=4, N_{L}=2, and X=1 is shown in Table 2, where two CPUs are required, one for each beam combination hypothesis.

TABLE 2
An example of CPU allocation with N_{TRP} = 4, N_{L} = 2, and X = 1.

CSI-RS resources

| | | | | |
|---|---|---|---|---|
| {L1, L2, L3, L4} | #1 | #2 | #3 | #4 |

| | |
|---|---|
| {2, 2, 2, 2} | CPU#1 |
| {4, 4, 4, 4} | CPU#2 |

For the number X of CPUs required for each of the N_{L} hypotheses, the wireless device 22 may indicate an integer value for X that is an integer between 1 and N_{TRP}. For instance, the wireless device capability value indicated may be X=3 when N_{TRP}=4 and N_{L}=2. In this case, the CPU allocation is given by Table 3.

TABLE 3
An example of CPU allocation with N_{TRP} = 4, N_{L} = 2, and X = 3.

CSI-RS resources

| | | | | |
|---|---|---|---|---|
| {L1, L2, L3, L4} | #1 | #2 | #3 | #4 |

| | |
|---|---|
| {2, 2, 2, 2} | CPU#1, CPU#2, CPU#3 |
| {4, 4, 4, 4} | CPU#4, CPU#5, CPU#6 |

In another embodiment, for the number X of CPUs required for each of the N_{L} hypotheses, the wireless device 22 may indicate an integer value for X that is an integer larger than N_{TRP}. This may be beneficial in case the wireless device 22 has to select a subset of TRPs from each hypothesis and may need additional processing units for TRP subset selection per hypothesis. For instance, the wireless device 22 capability value indicated may be X=5 when N_{TRP}=4 and N_{L}=2. In this case, the CPU allocation is given by Table 4.

TABLE 4
An example of CPU allocation with N_{TRP} = 4, N_{L} = 2, and X = 3.

| | CSI-RS resources | | | |
|---|---|---|---|---|
| {L1, L2, L3, L4} | #1 | #2 | #3 | #4 |

| | |
|---|---|
| {2, 2, 2, 2} | CPU#1, CPU#2, CPU#3, CPU#4, CPU#5 |
| {4, 4, 4, 4} | CPU#6, CPU#7, CPU#8, CPU#9, CPU#10 |

In another embodiment, the number of TRPs in each of the N_{L} hypothesis may be different. For example, one hypothesis may be {L1, L2, L3, L4}={2, 2, 0, 0} and the second hypothesis may be {L1, L2, L3, L4}={2, 2, 2, 2}. In this example, the number of TRPs involved in the first hypothesis is 2 (because the number of beams selected from TRPs 3 and 4 are zero, i.e., L3=L4=0), and the number of TRPs involved in the second hypothesis is 4. In this case, the number of CPUs occupied per hypothesis is different. That is, the number of CPUs occupied per 1^{st} hypothesis is X₁ (e.g., X₁=2) and the number of CPUs occupied per 2^{nd} hypothesis is X₂ (e.g., X₂=4). Alternatively stated, the number of CPUs occupied per hypothesis is determined by the number of CSI-RS resources (or TRPs) involved in the hypothesis. In this example, the number of CPUs occupied in O_{CPU}=X₁+X₂. In general, the number of hypothesis may be expressed as

$${O}_{C P U} = {\sum }_{i = 1}^{{N}_{L}} {X}_{i} .$$

In an alternative embodiment, the number of CPUs occupied is given by O_{CPU}=\tilde{X}N_{L}, where \tilde{X}=max{X₁, X₂, . . . , X_{N}_{_{L}}}. In the alternative embodiment, the number of CPUs occupied per hypothesis is determined by the hypothesis that has maximum number of CSI-RS resources involved. For example, if X₁=2 and X₂=4, then X=4 in the alternative embodiment.

In another embodiment, O_{CPU}=XN_{L}+Y, where Y is an integer and is either pre-determined or signalled by the wireless device 22 to the network node 16.

In some cases, the required CPU for the CJT CSI report may be composed of a number of components, where each component quantifies the number of required CPUs for a given functionality. For example, the total required CPU could be expressed as O_{CPU}=A+B+C, where
A is the number of CPUs required for measuring/estimating the channel associated with all configured CSI-RS resources/TRPs.
B is the number of CPUs required for down-selecting

$${N}_{L}^{′}$$

of the N_{L} configured hypotheses

$$( {N}_{L}^{′} < {N}_{L} ) .$$

Such down-selection can be performed based on a low complexity metric, e.g., wideband beam power, which has lower complexity than calculating the actual reported CSI/PMI, hence is faster to compute. If the wireless device 22 is not expected to perform down-selection, then B=0.
C is the number of CPUs required for calculating the CSI for the

$${N}_{L}^{′}$$

down-selected hypotheses.

Note that in the above example,

$${N}_{L}^{′}$$

is introduced for the purpose of explaining the motivation of the functionality-based CPU allocation, but

$${N}_{L}^{′}$$

could be established based on wireless device 22 implementation and

$${N}_{L}^{′}$$

may not be required to be explicitly known by the network node 16.

One non-limiting reason for dividing the CPU allocation based on functionality is that some calculations can be reused for different hypotheses. For example, if the wireless device 22 is configured with N_{L}=2 hypotheses, the first hypothesis being {L1, L2, L3, L4}={2, 2, 0, 0} and the second hypothesis being {L1, L2, L3, L4}={10, 2, 2, 2}. Then, the channel measurement/estimation can be performed based on the union of the configured CSI-RS resources/TRPs, so that the wireless device 22 does not have to calculate the channel estimate for some CSI-RS resources multiple times. In this example, the wireless device 22 will perform channel measurement for CSI-RS resources 1, 2, 3, 4 only once. In this way, the number of CPUs required for channel measurement/estimation scales with the number of configured CSI-RS resources/TRPs, not the number of configured hypotheses.

In one embodiment, A is a function of the number of configured CSI-RS resources/TRPs for CJT CSI reporting. For example, A=X_{chest}N_{TRP} where X_{chest} is the number of CPUs required for channel estimation for one CSI-RS resource. X_{chest} could also be a function that depends on the number of CSI-RS ports for a given CSI-RS resource. In a more generic form,

$$A = {Σ}_{n = 1}^{{N}_{TRP}} {X}_{chest}^{n} , where {X}_{chest}^{n}$$

is the number of required CPUs for the nth CSI-RS resource, which may depend on the number of ports in the nth CSI-RS resource. X_{chest} or

$${X}_{chest}^{n}$$

could be reported by the wireless device 22 as part of the wireless device capability or it could be a fixed value pre-determined in 3GPP specifications.

In one embodiment, B is fixed value. In one example, B could be signaled by the wireless device 22 via wireless device capability signaling. In another example, B is pre-determined in 3GPP specifications.

In another embodiment, B is a function of the number of configured hypotheses. For example, B=αN_{L}, where α is a scaler, which can be a fixed value. In one example, a could be signaled by the wireless device 22 via wireless device 22 capability signaling. In another example, α is pre-determined in 3GPP specifications.

In one embodiment, C is a fixed value. In one example, C could be signaled by the wireless device 22 via wireless device capability signaling. In another example, C is pre-determined in 3GPP specifications.

In another embodiment, C is a function of the number of configured hypotheses, e.g., C=βN_{L}.

In another embodiment, C is a function of the number of CSI-RS ports in a configured CSI-RS resource, e.g., C=βN_{CSI-RS}, where N_{CSI-RS} is the number of CSI-RS ports in a configured CSI-RS resource.

In yet another embodiment, C is a function of both the number of configured hypotheses and the number of CSI-RS ports in a configured CSI-RS resource, e.g., C=βN_{L}N_{CSI-RS}.

In the above embodiments related to C, the value of β could be a fixed value, which can either be reported by the wireless device 22 as part of the wireless device capability signaling, or it could be a pre-determined fixed value specified in 3GPP specifications.

Note that the above description with O_{CPU}=A+B+C is only an example as there could be more components or fewer components when determining O_{CPU}.

### Determining CPU Time Durations for a CJT CSI Report

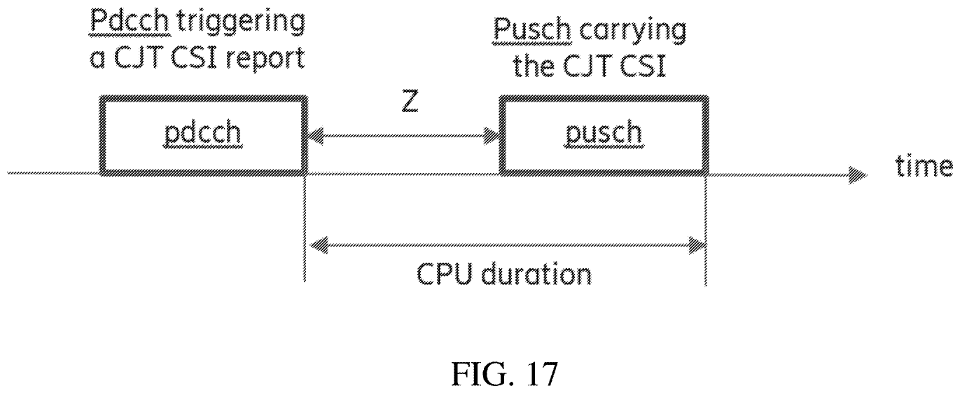

For aperiodic CJT CSI report, the CPUs are occupied starting from the end of a PDCCH triggering the CJT CSI to the last symbol of a PUSCH carrying the CSI. This is illustrated in FIG. 17, where Z corresponds to a delay requirement for aperiodic CJT CSI and may be pre-determined or signaled by the wireless device 22 as a wireless device capability.

For a semi-persistent CJT CSI on PUSCH,
For the initial CSI report after activation, the CPUs are occupied starting from the end of a PDCCH activating the CSI to the last symbol of a PUSCH carrying the CSI for the 1^{st} or initial PUSCH occasion.
For each of the remaining PUSCH occasions, the CPUs are occupied starting from the first symbol of the earliest one of the configured CSI-RS resources for channel measurement and CSI-IM resource(s) for interference measurement corresponding to respectively the latest CSI-RS/CSI-IM occasion no later than a corresponding CSI reference resource for the CSI report on the corresponding PUSCH occasion, until the last symbol of the PUSCH occasion, where the CSI reference resource is defined in 3GPP specification such as in, for example, clause 5.2.2.5 of 3GPP 38.214.

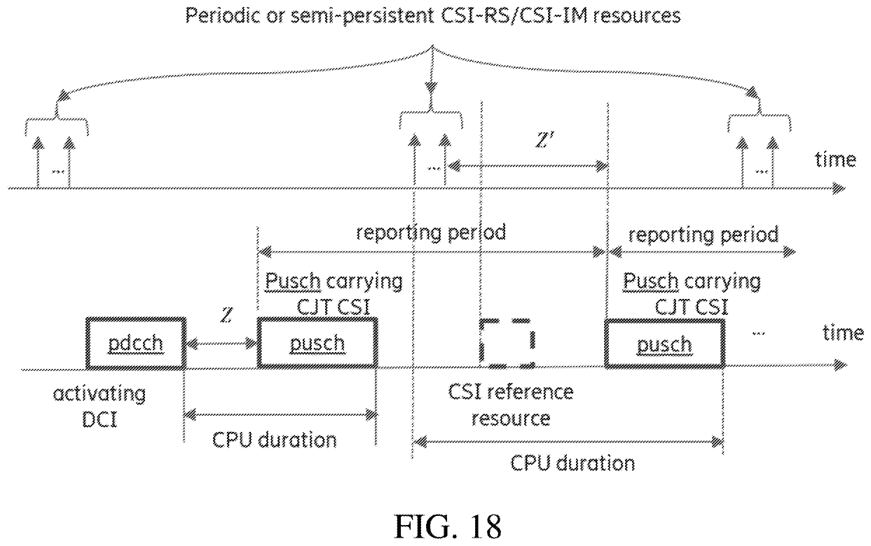

An example is shown in FIG. 18 for a semi-persistent CJT CSI report on PUSCH activated by a DCI, where Z′ corresponds to a delay requirement for CJT CSI and may be pre-determined or reported by a wireless device 22 as a wireless device capability.

Hence, according to one or more embodiments described herein, for a CJT CSI report configured with N_{TRP} NZP CSI-RS resources in a NZP CSI-RS resource set for channel measurement and N_{L} beam combination hypotheses, determining a total number of CPUs, O_{CPU}, for the CJT CSI report based on at least one of:

$${O}_{CPU} = {Σ}_{i = 1}^{{N}_{L}} {X}_{i} ,$$

where Xᵢ is the number of CPUs for the i^{th} hypothesis and it is either predetermined or reported by the wireless device 22;
O_{CPU}=XN_{L}, where X is the number of CPUs for each of hypotheses and it is either predetermined or reported by the wireless device 22;

$${O}_{CPU} = {Σ}_{i = 1}^{{N}_{L}} {X}_{i} + Y ,$$

where Y≥0 is an integer and is either predetermined or reported by the wireless device 22;
O_{CPU}=XN_{L}+Y, where Y≥0 is an integer and is either predetermined or reported by the wireless device 22; and/or
O_{CPU}=┌γN_{L}+KN_{TRP}, ┐, where γ is a scaling factor and K is the number of CPUs for each of the NZP CSI-RS resources, both y and K may be either pre-determined or reported by the wireless device 22.

One or more embodiments described herein provides the following advantage(s): for a given maximum number of CPUs supported by the wireless device 22, the method allows both the network node 16 and the wireless device 22 to determine whether the wireless device 22 has enough CPUs to process a CJT CSI report in a certain time duration, and, for example, configured the CSI report and/or CJT accordingly.

### Some Examples

Embodiment A1. A network node 16 configured to communicate with a wireless device 22, the network node 16 configured to, and/or comprising a radio interface 62 and/or comprising processing circuitry 68 configured to:
determine processing resources at a wireless device 22 that are required for the wireless device 22 to generate a channel state information, CSI, report for coherently joint downlink transmission, CJT; and
determine whether to trigger a CSI report at the wireless device 22 based at least on the determined processing resources.

Embodiment A2. The network node 16 of Embodiment A1, wherein the determining of processing resources corresponds to determining a number of central processing units, CPUs.

Embodiment A3. The network node 16 of Embodiment A1, wherein the CJT is configured with N_{TRP} NZP CSI-RS resources in a NZP CSI-RS resource set for channel measurement and N_{L} beam combination hypotheses, where N_{TRP} is an integer and N_{L} is an integer.

Embodiment A4. The network node 16 of Embodiment A3, wherein the determining of processing resources (O_{CPU}) is based on at least one of:

$${O}_{CPU} = {Σ}_{i = 1}^{{N}_{L}} {X}_{i} ,$$

where Xᵢ is the number of processing resources for the ith hypothesis;
O_{CPU}=XN_{L}, where X is number of processing resources for each of hypotheses;

$${O}_{CPU} = {Σ}_{i = 1}^{{N}_{L}} {X}_{i} + Y ,$$

where Y≥0 is an integer;
O_{CPU}=XN_{L}+Y, where Y≥0 is an integer; and
O_{CPU}=┌γN_{L}+KN_{TRP},┐, where γ is a scaling factor and K is the processing resources for each of the NZP CST-RS resources.

Embodiment A5. The network node 16 of any one of Embodiments A1-A4, wherein the network node 16 and/or the radio interface 62 and/or the processing circuitry 68 is further configured to receive wireless device capability of the wireless device 22, the wireless device capability indicating a number of processing resources required for each N_{L} hypotheses across the N_{TRP} CSI-RS resources.

Embodiment A6. The network node 16 of any one of Embodiments A1-A5, wherein the network node 16 and/or the radio interface 62 and/or the processing circuitry 68 is further configured to:
determine processing resources durations that are required for the wireless device 22 to generate the CSI report for CJT, the determining of whether to trigger the CSI report at the wireless device 22 being based at least on the determined processing resources durations.

Embodiment A7. The network node 16 of any one of Embodiments A1-A6, wherein the network node 16 and/or the radio interface 62 and/or the processing circuitry 68 is further configured to:
trigger the CSI report at the wireless device 22 based on the determination of whether to trigger the CSI report; and
receive the CSI report from the wireless device 22.

Embodiment B1. A method implemented by a network node 16 that is configured to communicate with a wireless device 22, the method comprising:
determining processing resources at a wireless device 22 that are required for the wireless device 22 to generate a channel state information, CSI, report for coherently joint downlink transmission, CJT; and
determining whether to trigger a CSI report at the wireless device 22 based at least on the determined processing resources.

Embodiment B2. The method of Embodiment B1, wherein the determining of processing resources corresponds to determining a number of central processing units, CPUs.

Embodiment B3. The method of Embodiment B1, wherein the CJT is configured with N_{TRP} NZP CSI-RS resources in a NZP CSI-RS resource set for channel measurement and N_{L} beam combination hypotheses, where N_{TRP} is an integer and N_{L} is an integer.

Embodiment B4. The method of Embodiment B3, wherein the determining of processing resources (O_{CPU}) is based on at least one of:

$${O}_{CPU} = {Σ}_{i = 1}^{{N}_{L}} {X}_{i} ,$$

where Xᵢ is the number of processing resources for the ith hypothesis;
O_{CPU}=XN_{L}, where X is number of processing resources for each of hypotheses;

$${O}_{CPU} = {Σ}_{i = 1}^{{N}_{L}} {X}_{i} + Y ,$$

where Y≥0 is an integer;
O_{CPU}=XN_{L}+Y, where Y≥0 is an integer; and
O_{CPU}=┌γN_{L}+KN_{TRP},┐, where γ is a scaling factor and K is the processing resources for each of the NZP CSI-RS resources.

Embodiment B5. The method of any one of Embodiments B1-B4, further comprising receiving wireless device capability of the wireless device 22, the wireless device capability indicating a number of processing resources required for each N_{L} hypotheses across the N_{TRP} CSI-RS resources.

Embodiment B6. The method of any one of Embodiments B1-B5, further comprising:
determining processing resources durations that are required for the wireless device 22 to generate the CSI report for CJT, the determining of whether to trigger the CSI report at the wireless device 22 being based at least on the determined processing resources durations.

Embodiment B7. The method of any one of Embodiments B1-B6, further comprising:
triggering the CSI report at the wireless device 22 based on the determination of whether to trigger the CSI report; and
receiving the CSI report from the wireless device 22.

Embodiment C1. A wireless device 22 configured to communicate with a network node 16, the wireless device 22 configured to, and/or comprising a radio interface 82 and/or processing circuitry 84 configured to:
receive an indication triggering a channel state information, CSI, report for coherently joint downlink, CJT, the indication triggering the CSI report being based at least on processing resources at the wireless device 22 that are required for the wireless device 22 to generate the CSI report for CJT;
perform at least one measurement associated with the CSI report for CJT; and
generate the CSI report for CSJ.

Embodiment C2. The wireless device 22 of Embodiment C1, wherein the processing resources correspond to a number of central processing units, CPUs.

Embodiment C3. The wireless device 22 of Embodiment C1, wherein the CJT is configured with N_{TRP} NZP CSI-RS resources in a NZP CSI-RS resource set for channel measurement and N_{L} beam combination hypotheses, where N_{TRP} is an integer and N_{L} is an integer.

Embodiment C4. The wireless device 22 of Embodiment C3, wherein the processing resources (O_{CPU}) are based on at least one of:

$${O}_{CPU} = {Σ}_{i = 1}^{{N}_{L}} {X}_{i} ,$$

where Xᵢ is the number of processing resources for the ith hypothesis;
O_{CPU}=XN_{L}, where X is number of processing resources for each of hypotheses;

$${O}_{CPU} = {Σ}_{i = 1}^{{N}_{L}} {X}_{i} + Y ,$$

where Y≥0 is an integer;
O_{CPU}=XN_{L}+Y, where Y≥0 is an integer; and
O_{CPU}=┌γN_{L}+KN_{TRP},┐, where γ is a scaling factor and K is the processing resources for each of the NZP CSI-RS resources.

Embodiment C5. The wireless device 22 of any one of Embodiments C₁-C₄, wherein the wireless device 22 and/or the radio interface 82 and/or the processing circuitry 84 is further configured to cause transmission of wireless device capability of the wireless device 22, the wireless device capability indicating a number of processing resources required for each N_{L} hypotheses across the N_{TRP} CSI-RS resources.

Embodiment C6. The wireless device 22 of any one of Embodiments C₁-C₅, wherein the indication triggering the CSI report is based at least on the processing resources durations that are required for the wireless device 22 to generate the CSI report for CJT.

Embodiment D1. A method implemented by a wireless device 22 that is configured to communicate with a network node 16, the method comprising:
receiving an indication triggering a channel state information, CSI, report for coherently joint downlink, CJT, the indication triggering the CSI report being based at least on processing resources at the wireless device 22 that are required for the wireless device 22 to generate the CSI report for CJT; and
performing at least one measurement associated with the CSI report for CJT; and
generating the CSI report for CSJ.

Embodiment D2. The method of Embodiment D1, wherein the processing resources correspond to a number of central processing units, CPUs.

Embodiment D3. The method of Embodiment D1, wherein the CJT is configured with N_{TRP} NZP CST-RS resources in a NZP CST-RS resource set for channel measurement and N_{L} beam combination hypotheses, where N_{TRP} is an integer and N_{L} is an integer.

Embodiment D4. The method of Embodiment D3, wherein the processing resources (O_{CPU}) are based on at least one of:

$${O}_{CPU} = {Σ}_{i = 1}^{{N}_{L}} {X}_{i} ,$$

where Xᵢ is the number of processing resources for the ith hypothesis;
O_{CPU}=XN_{L}, where X is number of processing resources for each of hypotheses;

$${O}_{CPU} = {Σ}_{i = 1}^{{N}_{L}} {X}_{i} + Y ,$$

where Y≥0 is an integer;
O_{CPU}=XN_{L}+Y, where Y≥0 is an integer; and
O_{CPU}=┌γN_{L}+KN_{TRP},┐, where γ is a scaling factor and K is the processing resources for each of the NZP CSI-RS resources.

Embodiment D5. The method of any one of Embodiments D1-D4, further comprising causing transmission of wireless device capability of the wireless device 22, the wireless device capability indicating a number of processing resources required for each N_{L} hypotheses across the N_{TRP} CSI-RS resources.

Embodiment D6. The method of any one of Embodiments D1-D5, wherein the indication triggering the CSI report is based at least on the processing resources durations that are required for the wireless device 22 to generate the CSI report for CJT.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented by a user equipment, the method comprising:
receiving from a network node an indication triggering a channel state information, CSI, report for coherent joint downlink transmission, CJT, the CSI report being based on a plurality of CSI reference signal, CSI-RS, resources;
determining a first number of CSI processing units, CPUs, required to process a CSI report based at least on a number of the plurality of CSI-RS resources and a second number of CSI processing units required for each of the plurality of CSI-RS resources;
processing the CSI report based on the determined first number of CSI processing units; and
reporting the CSI report to the network node.

2. The method of claim 1, wherein the first number of CSI processing units is based on a multiplication of the number of the plurality of CSI-RS resources and the second number of CSI processing units.

3. (canceled)

4. The method of claim 1, wherein the second number of CSI processing units is based on a number of CSI-RS ports for a CSI-RS resource.

5. The method of claim 1, wherein the first number of CSI processing units is further based on a third number of CSI processing units that are required for down-selecting at least one configured beam combination hypothesis.

6. The method of claim 5, wherein the third number of CSI processing units is equal to zero when the user equipment is not expected to perform down-selection.

7. The method of claim 1, wherein the first number of CSI processing units is further based on a fourth number of CSI processing units required for calculating a CSI for at least one down-selected configured beam combination hypothesis.

8. (canceled)

9. (canceled)

10. The method of claim 1, wherein the first number of CSI processing units is further based on a plurality of hypotheses of beam combinations, wherein each beam combination comprises a plurality number of beams associated with each of the plurality of CSI-RS resources.

11. (canceled)

12. A user equipment configured to:
receive from a network node an indication triggering a channel state information, CSI, report for coherent joint downlink transmission, CJT, the CSI report being based on a plurality of CSI reference signal, CSI-RS, resources;
determine a first number of CSI processing units, CPUs, required to process a CSI report based at least on a number of the plurality of CSI-RS resources and a second number of CSI processing units required for each of the plurality of CSI-RS resources;
process the CSI report based on the determined first number of CSI processing units; and
report the CSI report to the network node.

13. The user equipment of claim 12, wherein the first number of CSI processing units is based on a multiplication of the number of the plurality of CSI-RS resources and the second number of CSI processing units.

14. (canceled)

15. The user equipment of claim 12, wherein the second number of CSI processing units is based on a number of CSI-RS ports for a CSI-RS resource.

16. The user equipment of claim 12, wherein the first number of CSI processing units is further based on a third number of CSI processing units that are required for down-selecting at least one configured beam combination hypothesis.

17. (canceled)

18. The user equipment of claim 12, wherein the first number of CSI processing units is further based on a fourth number of CSI processing units required for calculating a CSI for at least one down-selected configured beam combination hypothesis.

19. (canceled)

20. (canceled)

21. The user equipment of claim 12, wherein the first number of CSI processing units is further based on a plurality of hypotheses of beam combinations, wherein each beam combination comprises a plurality number of beams associated with each of the plurality of CSI-RS resources.

22. (canceled)

23. A method implemented by a network node, the method comprising:
determining first number of channel state information, CSI, processing units required for a user equipment to process a CSI report for coherent joint downlink transmission, CJT, the first number of CSI processing units being based on a plurality of CSI reference signal, CSI-RS, resources configured for the CSI report and a second number of CSI processing units required for each of the plurality of CSI-RS resources; and
determining to trigger a CSI report from the user equipment based at least on the determination of the first number of CSI processing units.

24. (canceled)

25. The method of claim 23, wherein the second number of CSI processing units is based on a number of CSI-RS ports for a CSI-RS resource.

26. The method of claim 23, further comprising determining a third number of CSI processing units required for down-selecting at least one configured beam combination hypotheses.

27. (canceled)

28. The method of claim 23, further comprising determining a fourth number of CSI processing units required for calculating a CSI for at least one down-selected configured beam combination hypothesis.

29.-31. (canceled)

32. A network node configured to:
determine first number of channel state information, CSI, processing units required for a user equipment to process a CSI report for coherent joint downlink transmission, CJT, the first number of CSI processing units being based on a plurality of CSI reference signal, CSI-RS, resources configured for the CSI report and a second number of CSI processing units required for each of the plurality of CSI-RS resources; and
determine to trigger a CSI report from the user equipment based at least on the determination of the first number of CSI processing units.

33.-40. (canceled)
